(19) United States
(12) Patent Application Publication
(10) Pub. No.: US 2006/0245316 A1
(43) Pub. Date: Nov. 2, 2006

(54) Optical head and information recording/reproducing apparatus

(76) Inventors: Katsuo Iwata, Yokohama-shi (JP); Kazuhiro Nagata, Yokohama-shi (JP); Yuuichi Nakamura, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/410,137

(22) Filed: Apr. 25, 2006

(30) Foreign Application Priority Data
Apr. 27, 2005 (JP) 2005-129857

(51) Int. Cl. G11B 7/00

(52) U.S. Cl. 369/44.11

(57) ABSTRACT

To provide an optical head unit which is configured to provide a reproducing signal difficult to be influenced by vibrations when reproducing information from a recording medium of a corresponding standard by selectively using laser beams with different wavelengths, the distance between a beam split phase of a beam splitter and a photodetector is reduced by providing a ball lens on a beam split plane defined not parallel and not vertical to an axial line connecting an optical coupling prism and a beam splitter, and reducing the distance between a photodetector and a beam split plane of a beam splitter, as an embodiment of a disc apparatus.

### CROSS-REFERENCE TO RELATED APPLICATIONS

This application is based upon and claims the benefit of priority from Japanese Patent Application No. 2005-129857, filed Apr. 27, 2005, the entire contents of which are incorporated herein by reference.

### BACKGROUND

1. Field

One embodiment of the invention relates to an information recording/reproducing apparatus which records or reproduces information in/from an optical information recording medium or an optical disc, and an optical head incorporated in the information recording/reproducing apparatus.

2. Description of the Related Art

A long time has been passed since the commercialization of an optical disc capable of recording or reproducing information in a noncontact manner by using a laser beam, and an optical disc apparatus (an optical disc drive) which is capable of recording and reproducing information in/from an optical disc. Optical discs with several kinds of recording density called CD and DVD have become popular.

Recently, an ultra-high density optical disc HD (High Density) DVD (hereinafter abbreviated as HD DVD) using a laser beam with a blue or purple wavelength to record information to increase the recording density, has been put to practical use.

It is inefficient from the viewpoint of cost and installation place to prepare a different optical disc apparatus (a disk drive) for each of various types of optical disc. An optical disc apparatus is required to be capable of recording, reproducing and erasing information on/from optical discs of two or more standards.

A laser beam with a wavelength of 785 nm for example is used for recording, reproducing and erasing information on/from a CD standard optical disc that is already very popular. The wavelength of a laser beam used for a DVD standard disc is 655 nm, for example. The wavelength of a laser beam used for recording, reproducing and erasing information on/from a HD-DVD standard disc is 400 to 410 nm.

An optical disc apparatus includes a light transmitting system to radiate a laser beam with a fixed wavelength to a predetermined position on an optical disc (a recording medium), a light receiving system to detect a laser beam reflected by an optical disc, a mechanism control (servo) system to control the operations of the light transmitting system and light receiving system, and a signal processing system which supplies recording information and an erase signal to the light transmitting system, and reproduces recorded information from a signal detected by the light receiving system.

The light transmitting system and light receiving system include a semiconductor laser element (laser diode), and an object lens which condenses a laser beam from a laser diode on the recording surface of an optical disc and captures a laser beam reflected by an optical disc, which are formed as one unit called an optical head or optical pickup (head).

However, it increases the size and cost of an optical disc drive to prepare different optical heads for each wavelength of laser beam (optical disc standard) for recording or reproducing information in/from several standard optical discs.

In many optical heads or optical pickups, when recording or reproducing information in/from an optical disc, a monitoring photodetector monitors the intensity of a laser beam condensed on the recording surface of an optical disc through an object lens.

However, an optical head (optical pickup) including a monitoring photodetector is requested to be compact and lightweight as well as small size and low cost of an optical disc drive.

Japanese Patent Application Publication (KOKAI) No. 2001-33604 proposes using a ball lens as a condenser lens between a laser element and an object lens, to decrease the size of an optical pickup and the weight of a movable component.

Though a ball lens is available at a low cost, it may cause an optical axis deviation or wavefront distortion caused by profile accuracy, in a system using an optical beam with a wavelength of 655 nm for DVD and an optical beam with a wavelength of 405 nm for HD DVD, for example. Therefore, it is not always suitable to use a ball lens in an optical path of an optical beam for recording/reproducing through an object lens as in the above publication.

To achieve compactness of an optical pickup unit demanded nowadays, it is preferable to configure optics for monitoring as a system to take out a part of component used for information recording/reproducing of an optical beam passing through an object lens. But, at the position of a ball lens descried in the above Publication, it is substantially difficult to provide a monitoring optical system in the vicinity of the ball lens.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an optical disc apparatus in accordance with an embodiment of the invention;

FIG. 2 is an exemplary diagram showing an example of a diffraction element incorporated in an optical head of the optical disc apparatus shown in FIG. 1;

FIG. 3A is an exemplary diagram showing an example of an arrangement of the optical element (the ball lens) according to an embodiment of the invention; and

FIG. 3B is an exemplary diagram showing an example of an arrangement of the optical element (the conventional type lens).

### DETAILED DESCRIPTION

Various embodiments according to the invention will be described hereinafter with reference to the accompanying drawings. In general, according to one embodiment of the invention, an optical head unit which is configured to provide a reproducing signal difficult to be influenced by vibrations when reproducing information from a recording medium of a corresponding standard by selectively using laser beams with different wavelengths, the distance between a beam split phase of a beam splitter and a photodetector is reduced by providing a ball lens on a beam split plane defined not parallel and not vertical to an axial line connecting an optical coupling prism and a beam splitter, and reducing the distance between a photodetector and a beam split plane of a beam splitter, as an embodiment of a disc apparatus.

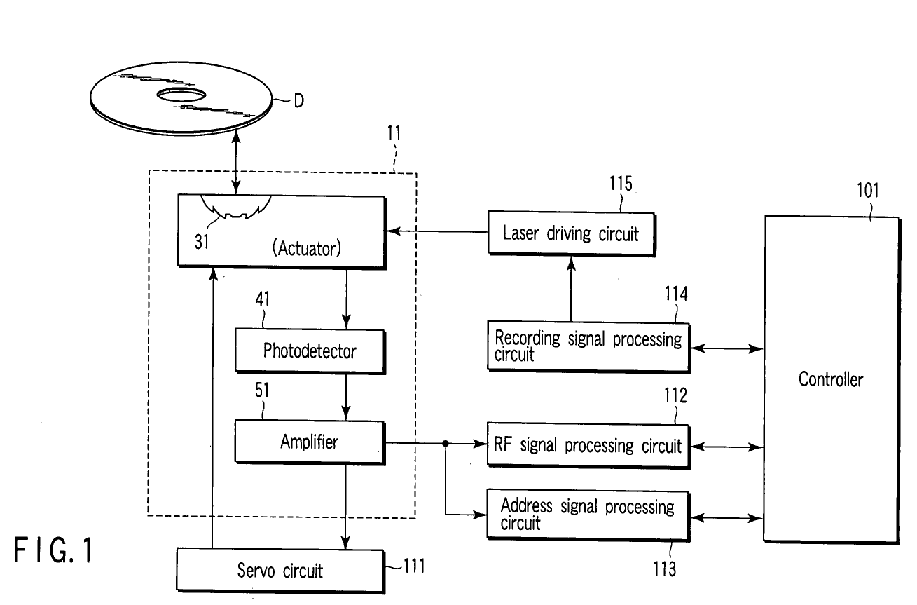

According to an embodiment, FIG. 1 shows an example of the configuration of an information recording/reproducing apparatus (an optical disc apparatus), to which the embodiments of the invention are applicable.

An optical disc apparatus 1 shown in FIG. 1 can record or reproduce information on/from an optical disc D, by condensing a laser beam of predetermined wavelength explained hereinafter from an optical pickup (PUH actuator) 11 on an information recording layer of an optical disc D corresponding to an optional kind (standard) explained hereafter. An optical disc D is an disc of CD or DVD standard, or a HD (high density) DVD disc with the recording density increased to higher than the CD and DVD standards.

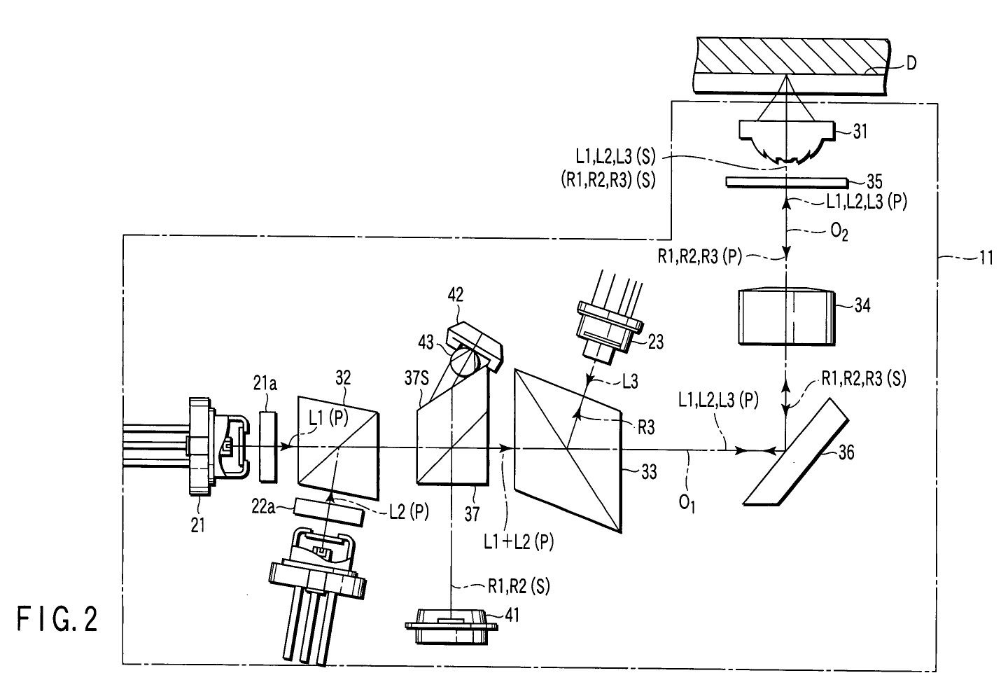

The PUH 11 can output any one of optical beams with first wavelength (405 nm), second wavelength (655 nm) and third wavelength (785 nm), according to the kind of a mounted optical disc D, as explained in a later paragraph with reference to FIG. 2. The PUH 11 detects a reflected laser beam reflected on a not-shown information-recording surface of the optical disk D, and outputs an output signal usable for reproducing information already recorded.

Specifically, the reflected laser beam reflected by the optical disc D is detected by a photodetector 41 of the PUH 11, and converted to an output signal with the size changed corresponding to the intensity of the light. The output signal of the photodetector 41 is amplified to a predetermined level by an amplifier 51, and output to a pickup servo circuit 111, RF signal processing circuit (output signal processing circuit) 112 and address signal processing circuit 113 which are connected to a controller (main control unit) 101.

The servo circuit 111 generates a focus servo signal (to control the difference in the distance between a recording layer of the optical disc D and an object lens, with respect to the focal position of an object lens) for an object lens of the PUH 11, and a tracking servo signal (to control the position of an object lens in the direction of crossing the track of the optical disc D), as explained in detail in a later paragraph with reference to FIG. 2. These signals are output to a not-shown focus actuator and tracking actuator, respectively.

The RF signal processing circuit 112 takes out user data and management information from a signal detected and reproduced by a photodetector. The address signal processing circuit 113 takes out address information, that is, information indicating a track or sector of the optical disc D opposed now to the object lens of the PUH 11. The taken-out information is output to the controller 101.

The controller 101 controls the position of the PUH 11 to read data such as user data at a desired position, or to record user data and management information at a desired position, based on the address information.

The controller 101 instructs an optical intensity of a laser beam to be output from a laser element (LD) when recording or reproducing information on/from the optical disc D. According to the instruction of the controller 101, the data recorded at an address of a desired position (or sector) can be erased.

When recording information on the optical disc D, (under the control of the controller 101) a recording signal processing circuit 122 supplies the laser driving circuit (LDD) 121 with a recording data, or a recording signal modulated to a recording waveform signal suitable for recording on the optical disc D. Therefore, the laser element of the PUH 11 emits a laser beam with the intensity changed according to recording information, corresponding to a laser driving signal output from the LDD 121. Information is recorded on the optical disc D by this.

FIG. 2 shows an example of the configuration of PUH (an optical pickup, or an optical head) of the optical disc apparatus shown in FIG. 1.

The PUH 11 includes a first light source 21 that is a semiconductor laser element, for example. The wavelength of an optical beam emitted from the first light source 21 is 400 to 410 nm, preferably 405 nm. The PUH 11 also includes a second light source 22 that is a semiconductor laser element, for example. The wavelength of an optical beam emitted from the second light source 22 is preferably 655 nm. The PUH 11 also includes a third light source 23 that is a semiconductor laser element, for example. The wavelength of an optical beam emitted from the third light source 23 is preferably 785 nm. The first and second light sources 21 and 22 are provided with λ/2 plates 21a and 22a for adjusting the polarization direction of an emitted laser beam (for changing the ratio of P-polarization to S-polarization to a predetermined ratio), nearby (or as one body).

At a predetermined position of the PUH 11 opposite to the optical disc, an object lens 31 is provided. The object lens condenses the laser beam emitted from one of the first to third light sources 21 to 23 according to the kind of the optical disc D set in the optical disc apparatus 1 shown in FIG. 1, on a not-shown recording surface of the optical disc D, and captures the reflected laser beam reflected on the recording surface. The object lens 31 is a lens applicable to three wavelengths and capable of providing a predetermined numerical aperture (NA) for each laser beam output from the first to second laser elements 21 and 23. The object lens 31 is made of plastic, and has a numerical aperture NA of 0.65 for a laser beam with a wavelength of 405 nm, and 0.6 for a laser beam with a wavelength of 655 nm, for example.

Between the first to third laser elements (light sources) 21 to 23 and the object lens 31, the first optical coupling prism 32, second coupling prism 33, collimator lens 34, and optical diffraction element 35 composed of a polarization dependent diffraction element formed on an optical glass with a predetermined thickness are arranged in this order from the first laser element 21. The optical diffraction element 35 may be formed integrally with a known λ/4 plate. (In the following explanation, a λ/4 plate is provided integrally with the optical diffraction element 35 in this example.) Usually, in designing an optical path or for decreasing the thickness of the PUH 11, a mirror 36 for bending the optical path (usually called a rising mirror) is provided between the collimator lens 34 and optical diffraction 34 or between the collimator lens 34 and second optical coupling prism 33.

Between the first optical coupling prism 32 and second optical coupling prism 33, a beam splitter 37 is provided. The beam splitter transmits most laser beam traveling from the first optical coupling prism 32 to the second optical coupling prism 33 (namely, from the first light source 21 to the optical disc D), and reflects the reflected laser beam reflected on the recording surface of the optical disc D at a predetermined ratio.

In the traveling direction of the reflected laser beam reflected by the beam splitter 37, a photodetector 41 is provided. The photodetector detects a reflected laser beam reflected on the recording/reproducing surface of the optical disc D, and outputs an electric signal corresponding to the light intensity of the reflected laser beam. The beam splitter 37 is a polarization beam splitter having a plane of polarization set to transmit a P-polarized component and reflect a S-polarized component. A part of laser beams L1 and L2 from the first and second light sources, that is, a S-polarized component is separated from the laser beam traveling to the optical disc D by being reflected on the plane of polarization.

A photodetector 42 for power monitor (APC) (hereinafter called an APC detector) is provided at a predetermined position, so that the beam splitter 37 can detect a laser beam (S-polarized) separated from a laser beam (P-polarized) traveling to the optical disc D. Therefore, the APC detector 42 can be used for either a laser beam with a wavelength of 405 nm (for HD DVD) or laser beam with a wavelength of 655 nm (for DVD). Between the APC detector 42 and polarization beam splitter 37 (exit plane 37S), a ball lens 43 is provided to condense a S-polarized laser beam emitted from the exit plane 37S on the light-receiving plane of the APC detector 42. The ball lens 43 has a short focal distance compared with a collimator lens often used in a stage before an APC detector, and can reduce the distance between the exit plane 37S of the polarization beam splitter 37 and the light-receiving plane of the APC detector 42. The ball lens 43 is glued with an adhesive (not shown) to the light-receiving plane of the APC detector 42 or the exit plane of the polarization beam splitter 37, or the both. Of course, the ball lens fixing means is not limited to an adhesive. The ball lens 43 may be pressed to the light-receiving plane of the APC detector 42 or the exit plane of the polarization beam splitter 37, by using a leaf spring (elastic body).

The first coupling prism (dichroic prism) 32 transmits the laser beam L1 with a wavelength of 405 nm (400 to 410 nm) emitted from the first light source or semiconductor laser element 21 for HD DVD, and reflects the laser beam L2 with a wavelength of 655 nm (640 to 670 nm) emitted from the second light source or semiconductor laser element 22 for DVD, thereby coupling both laser beams on the same optical path. The first optical coupling prism 32 is demanded to transmit the laser beam L1 from the first light source 21 without substantially decreasing the intensity. Thus, the reflectivity is 0% (except the reflection on the base material surface) for a laser beam with a wavelength shorter than 655 nm, for example. It is known that a wavelength of a laser beam output from a laser element is usually fluctuated by 10 nm/5° C., for example, by fluctuations in the temperature of a laser element and ambient temperature. A central wavelength of an output laser beam is different by individuals. Therefore, actually, a wavelength area of film characteristic inverting wavelength band is of course defined including the influence of the temperature fluctuations.

Contrarily, the second optical coupling prism 33 (trichroic prism) must transmit the laser beams from the first and second light sources 21 and 22 (reflect only the laser beam with a wavelength of 785 nm (775 to 795 nm) from the third light source 23). Therefore, the reflectivity is 0% (except the reflection on the base material surface) for a laser beam with a wavelength shorter than 785 nm, for example. Therefore, a film characteristic inverting wavelength band (wavelength band to invert the characteristics of reflection and transmission) is defined preferably to 655 to 785 nm. Of course, it is known that a wavelength of a laser beam output from a laser element which outputs a laser beam of a wavelength of 785 nm is also fluctuated by 10 nm/5° C., for example, by fluctuations in the temperature of a laser element and ambient temperature. A central wavelength of an output laser beam is different by individuals. Therefore, actually, a wavelength area of film characteristic inverting wavelength band is of course defined including the influence of the temperature fluctuations.

Next, a detailed explanation will be given on radiation of a laser beam from the PUH shown in FIG. 2, and a laser beam from an optical disc.

The laser beam L1 with a wavelength of 405 nm emitted from the first light source 21 is changed in the polarization direction by the λ/2 plate 21a, so that the number of P-polarized components is more than S-polarized components. The laser beam L1 changed in the polarization direction is guided to a rising mirror 36 through the first optical coupling prism 32, beam splitter 37 and second optical coupling prism 33. The rising mirror 36 reflects the laser beam L1 and changes the traveling direction. The laser beam L1 is guided to the object lens 31 through the collimator lens 34 and optical diffraction element 35. The object lens 31 condenses the laser beam L1 on a not-shown recording surface of the optical disc D. The polarization direction of the laser beam L1 after transmitting through the optical diffraction element 35 is circular at a point when it is further rotated by the integrated λ/4 plate and radiated to the optical disc D.

The laser beam L2 with a wavelength of 655 nm emitted from the second light source 22 is changed in the polarization direction by the λ/2 plate 22a, so that the number of P-polarized components is more than S-polar-ized components. The laser beam L2 changed in the polarization direction is reflected by the first optical coupling prism 32, and guided to the rising mirror 36 along substantially the same optical path as the first laser beam L1, through the beam splitter 37 and second optical coupling prism 33. The laser beam L2 reflected by the rising mirror 36 is converted to a circularly polarized light by the λ/4 plate 35 formed integrally with a diffraction element, and condensed on a not-shown recording surface of the optical disc D by the object lens 31, like the first laser beam L1.

The laser beam L3 with a wavelength of 785 nm emitted from the third light source 23 is reflected by the second optical coupling prism 33, and guided to the rising mirror 36 along substantially the same optical path as the first and second laser beams L1 and L2. The laser beam L3 is reflected by the rising mirror 36, and condensed to a not-shown recording surface of the optical disc D by the object lens 31, like the first and second laser beams L1 and L2.

The S-polarized component of the laser beam coupled by the first coupling prism 32, separated from the laser beam traveling to the optical disc D by the beam splitter 37, and emitted from the exit plane 37S of the beam splitter 37, that is, the laser beam with a wavelength of 405 nm from the first light source 21 and laser beam with a wavelength of 655 nm from the second light source 22, is given a predetermined convergence by the ball lens 43, and radiated to the light-receiving plane of the APC detector 42. In this time, the laser beam guided to the ball lens 43 is not parallel and not vertical to the optical axis 01 between the first and second optical coupling prisms 32 and 33. Namely, the S-polarized component of the laser beam with a wavelength of 405 nm from the first light source 21 and laser beam with a wavelength of 655 nm from the second light source 22 is radiated to the APC detector 42.

The output of the APC detector 42 is used to control the largeness of a laser driving current to be supplied to a laser element outputting that laser beam, by feedback control, though not explained in detail.

The reflected laser beam (R1 to R3) reflected on the recording surface of the optical disc D is captured by the object lens 31 and returned to the optical diffraction element 35. The characteristics of the reflected laser beams R1, R2 and R3 will be explained hereinafter.

The polarization direction of the laser beam R1 with a wavelength of 405 nm is changed from circular to linear in the optical diffraction element 35. The polarization direction of this reflected laser beam R1 is different 90° from the polarization direction of the laser beam L1 traveling to the optical disc D.

The traveling direction of the reflected laser beam R1 changed in the polarization direction is changed by the rising mirror 36, and returned to the polarization beam splitter 37 through the second optical coupling prism 33.

As the polarization direction of the reflected laser beam R1 returned to the polarization beam splitter 37 has been changed 90° from the polarization direction when traveling to the optical disc D, and the laser beam R1 is then reflected by the polarization beam splitter 37 and guided to the photodetector 41.

The reflected laser beam R1 guided to the photodetector 41 is converted to an output signal corresponding to the intensity in the photodetector 41, and processed by a signal processor shown schematically in FIG. 1. Therefore, the information recorded in the optical disc D is reproduced.

The polarization direction of the laser beam R2 with a wavelength of 655 nm is changed from circular to linear in the optical diffraction element 35. The polarization direction of this reflected laser beam R2 is different 90° from the polarization direction of the laser beam L2 traveling to the optical disc D.

The traveling direction of the reflected laser beam R2 changed in the polarization direction is changed by the rising mirror 36, and returned to the polarization beam splitter 37 through the second optical coupling prism 33.

As the polarization direction of the reflected laser beam R2 returned to the polarization beam splitter 37 has been changed 90 from the polarization direction when traveling to the optical disc D, and the laser beam R2 is then reflected by the polarization beam splitter 37 and guided to the photodetector 41.

The reflected laser beam R2 guided to the photodetector 41 is converted to an output signal corresponding to the intensity in the photodetector 41, and processed by a signal processor shown schematically in FIG. 1. Therefore, the information recorded in the optical disc D is reproduced.

Like the laser beams R1 and R2, the laser beam R3 with a wavelength of 785 nm is reflected by the rising mirror 36, and returned to the second optical coupling prism 33. As already explained, the film characteristic inverting wavelength band of the second optical coupling prism 33 is 655 to 785 nm, and the laser beam R3 is reflected to the laser element 23 regardless of the polarization direction of the plane of polarization.

A given reproducing signal of CD can be obtained by adding the third laser element 23 to a laser oscillator, and constructing a photodetector as one body with a detection element.

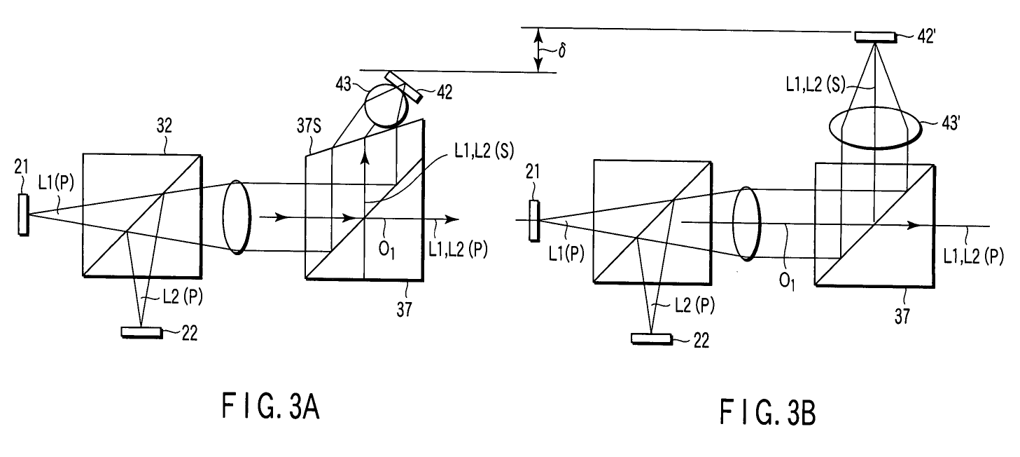

FIGS. 3A and 3B explain the characteristics of an optical coupling prism and a polarization beam splitter incorporated in the PUH (optical pickup) shown in FIG. 2.

FIG. 3A shows the first and second light sources 21 and 22, first optical coupling prism 32, polarization beam splitter 37, APC photodetector 42 and ball lens 43 of the PUH shown in FIG. 2. FIG. 3B shows an example of forming an image of a laser beam reflected by the polarization beam splitter 37, in a photodetector (32′) through an ordinary image-forming lens (43′), for the comparing purpose.

As seen from FIGS. 3A and 3B, the distance from the optical axis O1 to the farthest APC photodetector 42 (42′) can be reduced by δ by using the ball lens 43. By setting the exit plane 37S of the polarization beam splitter 37 to an optimum angle, the ball lens 43 can be tightly stuck to the exit plane 37S of the polarization beam splitter 37 (the distance δ can be increased to a maximum). In this case, an angle (angle of deviation of optical path) formed by the optical axis O1 and the laser beam (S-polarized L1, L2) toward the ball lens 43 is preferably 60±50 (the angle of the exit plane 37S is defined to be capable of emitting a laser beam to be input to the ball lens 43 at an angle of deviation of optical path of 60±5° with respect to the optical axis O1). Namely, a laser beam guided to the ball lens 43 forms an image on the light-receiving plane of the photodetector at a shortest distance where the distance between the exit plane 37S and the light-receiving plane of the photodetector 42 is identical to the diameter of the ball lens, by positioning all laser beams from the exit plane 37S of the polarization beam splitter 37 enterable. A laser beam guided to the ball lens 43 is increased in its optical use efficiency by beam shaping on the exit plane 37S of the polarization beam splitter 37, and the S/N ratio is increased. Therefore, stable APC operation is possible.

As explained hereinbefore, by using an embodiment of the present invention, by arranging three light sources capable of emitting the first to third wavelength beams of the invention, and providing a wavelength selection film (optical coupling prism) related to the arrangement of these light sources, an optical beam with a wavelength of 405 nm for HD DVD and an optical beam with a wavelength of 655 nm for DVD are coupled by a dichroic mirror, and power monitor (APC) is possible from a component (S-polarized) reflected by a polarization beam splitter, before the both beams reach an optical disc. Further, by guiding a laser beam to an APC photodetector by using a ball lens, the distance (the size of an optical head) is decreased, compared with guiding a laser beam to a photodetector by using an ordinary lens. A laser beam guided to a ball lens is increased in its optical use efficiency by beam shaping in a polarization beam splitter, and an S/N ratio is increased, and stable APC operation is possible.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical head unit comprising:
a first light source which outputs light with a shortest wavelength;
a second light source which outputs light with a second wavelength longer than the wavelength of the light from the first light source;
a third light source which outputs light with a third wavelength longer than both lights from the first and second light sources;
a first optical coupling prism which transmits the light from the first light source, between the first light source and second light source, reflects the light from the second light source, and synthesizes these lights;
a second optical coupling prism which transmits the light synthesized by the first optical coupling prism, reflects the light from the third light source, and synthesizes these lights;
a beam splitter which outputs light with a shortest wavelength,
a first light source which is provided between the first and second optical coupling prisms, transmits/reflects at least a part of the light synthesized by the first optical coupling prism, and outputs light with a shortest wavelength reflected by a recording medium;
a monitor photodetector which detects at least a part of the light synthesized by the first optical coupling prism reflected by the beam splitter, and generates an output signal corresponding to the intensity of the light; and
a ball lens which is provided between the beam splitter and monitor photodetector, and inputs the light emitted from the beam splitter to the monitor photodetector, not parallel and not vertical to an axial line between the first and second optical coupling prisms.

2. The optical head unit according to claim 1, wherein an exit plane to emit light from the beam splitter to the monitor photodetector is not parallel and not vertical to an axial line defined between the first and second optical coupling prisms.

3. The optical head unit according to claim 1, wherein an angle formed by light passing through the center of the ball lens and the axial line defined between the first and second optical coupling prisms is 60±5°.

4. The optical head unit according to claim 2, wherein an angle formed by light passing through the center of the ball lens and the axial line defined between the first and second optical coupling prisms is 60±5°.

5. The optical head unit according to claim 1, wherein the ball lens and the exit plane of the beam splitter are brought into contact through an adhesive.

6. The optical head unit according to claim 2, wherein the ball lens and the exit plane of the beam splitter are brought into contact through an adhesive.

7. The optical head unit according to claim 3, wherein the ball lens and the exit plane of the beam splitter are brought into contact through an adhesive.

8. An optical head unit comprising:
a first light source which outputs light with a shortest wavelength;
a second light source which outputs light with a second wavelength longer than the wavelength of the light from the first light source;
a third light source which outputs light with a third wavelength longer than both lights from the first and second light sources;
a first optical coupling prism which transmits the light from the first light source, between the first light source and second light source, reflects the light from the second light source, and synthesizes these lights;
a second optical coupling prism which transmits the light synthesized by the first optical coupling prism, reflects the light from the third light source, and synthesizes these lights;
a beam splitter which is provided between the first and second optical coupling prisms, to transmit at least a part of the light synthesized by the first optical coupling prism and reflect the rest, to reflect light reflected by a recording medium, and to emit the light synthesized by the first optical coupling prism not parallel and not vertical to an axial line, between the first and second optical coupling prisms, when emitting by reflecting the light;
a monitor photodetector which detects light emitted from an exit plane of the beam splitter, and generates an output signal corresponding to the intensity of the light; and
a ball lens which is provided between the exit plane of the beam splitter and the monitor photodetector, and inputs the light emitted from the beam splitter to the monitor photodetector.

9. An information recording/reproducing apparatus comprising:
an optical head unit; and
a signal reproducing circuit which takes out a signal component corresponding to information from a signal detected by the photodetector, to reproduce the information recorded in a recording medium.

10. The information recording/reproducing apparatus according to claim 9, wherein an angle formed by the light passing through the center of the ball lens and the axial line defined between the first and second optical coupling prisms in the optical head unit is 60±5°.

11. The information recording/reproducing apparatus according to claim 9, further comprising a photodetector which is provide at a predetermined position in the direction that the beam splitter reflects the light reflected by a recording medium, and generates an output signal corresponding to the intensity of the reflected light.
